(19) United States
(12) Patent Application Publication
(10) Pub. No.: US 2019/0139151 A1
(43) Pub. Date: May 9, 2019

(54) CROWDFUNDED TRAVEL BASED ON ENTERTAINMENT VALUE

(71) Applicant: Paul Leger, Marlborough, MA (US)

(72) Inventor: Paul Leger, Marlborough, MA (US)

(21) Appl. No.: 16/007,468

(22) Filed: Jun. 13, 2018

Related U.S. Application Data
(60) Provisional application No. 62/518,722, filed on Jun. 13, 2017.

(51) Int. Cl. G06Q 50/00; G06Q 30/02; G06Q 20/10; G06F 16/43

(52) U.S. Cl. CPC G06Q 50/01; G06Q 30/0255; G06F 3/0482; G06F 16/43; G06Q 20/10

(57) ABSTRACT

A server and media repository associates travelers with funding entities based on viewing an entertaining media item authored by the traveler and viewed by the funding entity, such as a browsing viewer who is favorably inclined by the entertaining media item. User travelers generate an entertaining video or other media (slideshow, accompanying audio, etc.) for querying and viewing by an online user community of viewers. The user has a vacation destination for which the entertaining media item is promulgating funding requests for, and the viewer may query and browse/view the entertaining media items based on the destination or other factors. A viewer favorably disposed by viewing the entertaining media item may elect to contribute to funding the travel expenses of the user to the destination. Advertisers provide additional revenue by purchasing media space/time for promotional media alongside the entertaining media items.

### RELATED APPLICATIONS

This patent application claims the benefit under 35 U.S.C. § 119(e) of U.S. Provisional Patent App. No. 62/518,722, filed Jun. 13, 2017, entitled “CROWDFUNDED TRAVEL BASED ON ENTERTAINMENT VALUE,” incorporated by reference in entirety.

### BACKGROUND

Modern network technology has evolved to allow rapid sharing of information including photographs, recordings, documents, and video between distant parties. Concurrently, electronic commerce facilitates financial transactions across public access networks such as the Internet. Financial transactions between parties that never meet face-to-face are enabled through online bidding and retail sites that facilitate financial transactions between buyers and sellers. Similarly, such information is also shared with friends and relatives through sites which store and render the information.

### SUMMARY

A server and media repository associates travelers with funding entities based on viewing an entertaining media item authored by the traveler and viewed by the funding entity, such as a browsing viewer who is favorably inclined by the entertaining media item. User travelers generate an entertaining video or other media (slideshow, accompanying audio, etc.) for querying and viewing by an online user community of viewers. The user has a vacation destination for which the entertaining media item is promulgating funding requests for, and the viewer may query and browse/view the entertaining media items based on the destination or other factors. A viewer favorably disposed by viewing the entertaining media item may elect to contribute to funding the travel expenses of the traveler to the destination. Advertisers provide additional revenue by purchasing media space/time for promotional media alongside the entertaining media items.

Configurations herein are based, in part, on the observation that crowdfunding has become a popular revenue gathering vehicle on public access networks such as the Internet. Self-proclaimed deserving parties promote a cause or expense via a webpage describing the cause and financial need thereof. Electronic payment methods facilitate donations by viewing parties. However, conventional approaches to crowdfunding suffer from the shortcoming that the would-be donator is not incentivized to contribute. Generally, crowdfunded approaches focus on a sympathetic or charitable appeal for a selfless need, and rely on the philanthropic nature of the contributor. Accordingly, configurations herein substantially overcome the charity-based model of crowdfunded revenue by providing an entertainment venue and appreciation model, such that viewers may browse for videos and other renderable media based on an entertainment value sought via a query. A rendering server allow viewers to compensate the performer/users based on a stated travel destination that is the impetus for seeking funds. Additional revenue outlets are provided for advertising media in conjunction with the entertaining media items generated by the users.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a media content exchange environment suitable for use with configurations herein;

FIG. 2 is a flowchart of a media rendering server in the environment of FIG. 1;

FIG. 3 is a diagram of a traveler user interface rendered by the server of FIG. 2;

FIG. 4 is an administrator interface for evaluating new travelers invoked by the traveler interface of FIG. 3;

FIG. 5 is a home page invokable by viewers for previewing entertaining media items uploaded by the traveler interface of FIG. 3;

FIG. 6 is a viewer interface invokable to enter funds for dissemination to travelers;

FIG. 7 is a dashboard view accessible from the traveler interface or the viewer interface;

FIG. 8 is a rendering screen for viewing entertaining media items and selecting a donation amount;

FIG. 9 is an advertiser interface for indicating commercial interests in a travel destination; and

FIG. 10 is an administrative dashboard for identifying entertaining media items uploaded by travelers and rendered to viewers.

### DETAILED DESCRIPTION

Configurations below implement a social fundraising platform for individuals to pursue their travel dream by bringing their respective talent to the market and entertaining the entire network-visible world. The platform is a portal for individuals to entertain themselves and fund the entertainers to fulfill their travel dreams. The platform welcomes users to entertain themselves, entertain public viewers and pursue funded, business partners to advertise with the platform, and also promotes the videos through affiliated media platforms as well.

The social platform provides an ability for individual(s) to post an entertaining video on the platform and share the video in hopes of it “going viral”, or at least having substantial popularity. The platform will allow people to upload any kind of entertainment videos to entertain the network browsing audience and encourage them to fund their travel goal. The videos may be categorized as a type such as hilarious/emotional/influential/mimicry etc. The campaigning will be launched publicly and encourage contributions to raise funds. Advertising revenue, possibly by travel sponsors, also maintains the platform by including a third-party video editor to allow administrative entities to post advertising campaigns over the posted videos before being live, or for rendering banner-type ads in screen perimeter regions.

In a public networking environment, configurations disclosed herein teach a method of associating entertainment compensation with travel funding by receiving, from a user, an entertaining media item for appealing to a plurality of viewers receiving the entertaining media item via the public network, and receiving, in conjunction with the entertaining media item, a destination for which travel funding is sought by the user. A funding-seeking user performs or otherwise generates a video having entertaining content in view of obtaining funding for vacation travel to a destination. While the video need not contain content directed to the destination, the destination is associated with the video and that destination is an available and queryable by the viewer. A viewer GUI (graphical user interface) disseminates, based on a request from a browsing user, the entertaining media item, and associates, based on an approval of a viewer of the plurality of viewers, a monetary contribution from the view towards a travel expense incurred by the user in traveling to the destination. Thus, an appreciative or entertained viewer is incentivized to contribute toward the travel plans of the user.

The publicly available GUI allows receiving, from at least one viewer of the plurality of viewers, a query for available entertaining media items, such that the dissemination is based on the query corresponding to the destination. A user creates the content of the entertaining media item based on persuasion of a viewer to donate monetarily towards travel by the user to the destination. In other words, the user wants to entice the viewer into contributing by exhibiting a talented, humorous and/or entertaining video. An amount of any resulting voluntary monetary contribution is based on a perceived entertainment level of the entertaining media item to the viewer. It is expected that the entertaining media item includes one or a sequence of a video track, audio track or still image, such as a mobile device captured video or a rendering of a vocal performance of a song, as is frequently a subject of many audition-style television programs. The traveling user may use the entertaining media item to associate the travel destination with an impetus for traveling there, but the content of the entertaining media item is not restricted by the subject of the destination.

Promotional advertiser revenue and content is also facilitated by receiving, from an advertiser, the promotional content, and rendering, to the viewers, the promotional content during receipt of the entertaining media item. Generally, the promotional content includes at least one of a video segment rendered prior to dissemination of the entertaining media item, or a banner rendered in a margin area surrounding the disseminated entertaining media, however any suitable promotional media may be employed.

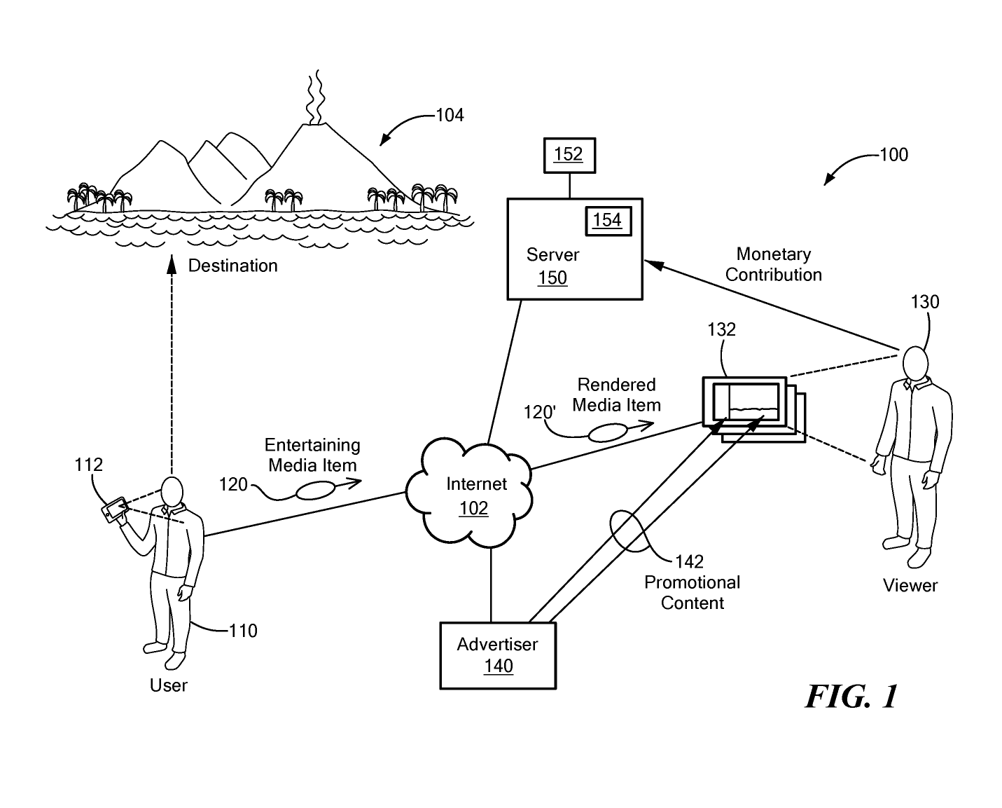

FIG. 1 is a context diagram of a media content exchange environment suitable for use with configurations herein. Referring to FIG. 1, in a public networking environment 100 a method of associating entertainment compensation with travel funding includes receiving, from a traveling user (traveler) 110, an entertaining media item 120 for appealing to a plurality of viewers 130 receiving the entertaining media item via s public network 102 such as the Internet. The traveler 110 seeks to procure funding for travel to a destination 104. Thus, a server 150 receives, in conjunction with the entertaining media item 120, an indication of the destination 104 for which travel funding is sought by the user traveler 110. Using the network 102, the server 150 disseminates, based on a request from a browsing (viewing) user 130, the entertaining media item 120.′ If the viewer 130 appreciates the traveler's media item 120, a donation may be made. The server 150 associates, based on an approval of a viewer 130 of the plurality of viewers, a monetary contribution from the view towards a travel expense incurred by the traveler 110 in traveling to the destination 104

The entertaining media item 120 is captured by any suitable device, typically a mobile device 112 of the traveler 110, and includes one or a sequence of a video track, audio track or still image. The server 150 includes a database 152 for storing the uploaded entertaining media items 120, which allows the viewer 130 to peruse or query to find a rendered media item 120′ to their liking. A plurality of viewers 130 may access and view via any suitable mechanism, such as a mobile device 132 or other Internet conversant device including fixed televisions, desktops, laptops, etc.

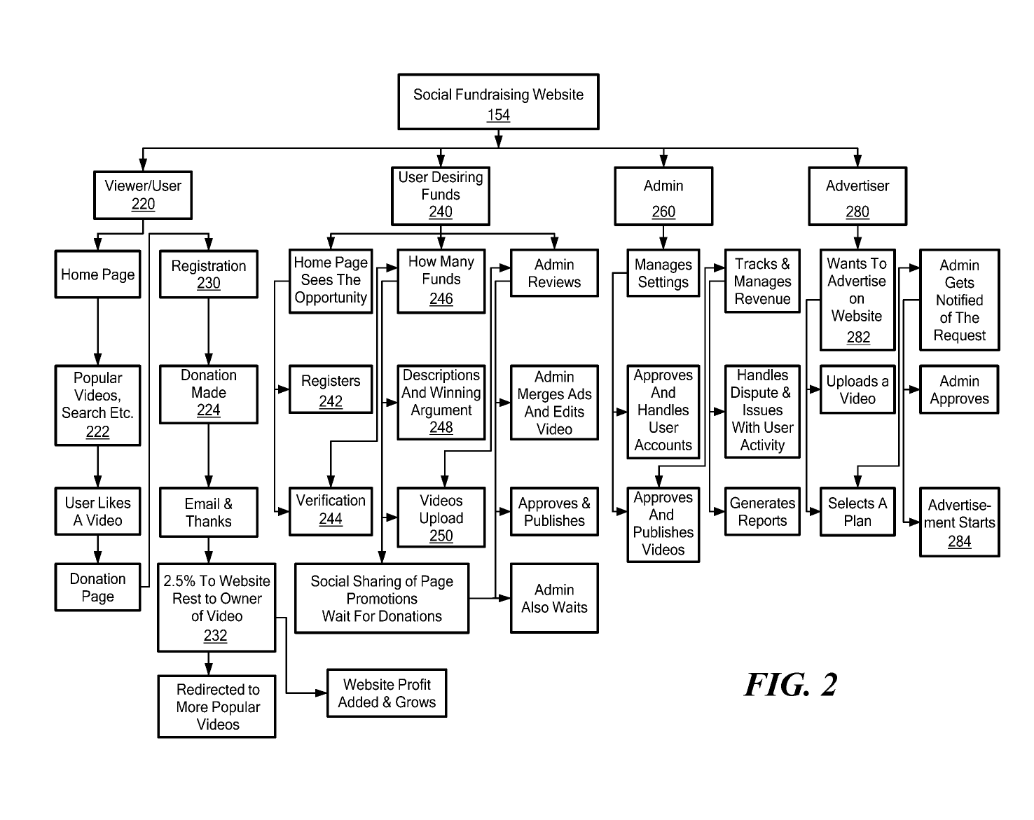

As the traveler 110 is associated with a particular destination 104 for which funding is sought, advertisers may also inject promotional content 142 pertaining to the destination, such as hotel, airfare, restaurants and other commercial aspects which may appeal to travelers, discussed further below. A fundraising website 154 coordinates the user interfaces, media content and monetary exchanges, discussed further in FIG. 2.

FIG. 2 is a flowchart of a media rendering server in the environment of FIG. 1. Referring to FIGS. 1 and 2, the environment 100 includes travelers, viewers and advertisers (all users of the server 150 however the specific labels will be retained for clarity). The server 150 launches and executes a website 154 for providing the disclosed operations. The website 154 employs and renders user interfaces directed to viewers 220, travelers 240, administrators 260, and advertisers 280. The website 154 renders the user interface 220 for a viewer responsive to entertaining media items uploaded via the traveler user interface, renders user interface 240 for a traveler seeking funding, and renders user interface 280 for advertisers to specify commercial media. The administration interface 260 includes activities for overseeing user registration, media content and other tasks associated with administration of the user community.

A typical scenario commences with a traveler seeking funds to travel to a destination 104. The traveler is afforded an opportunity to appeal to and entertain viewers with their entertaining media item 120 to entice a monetary transfer toward funding travel to the destination. Initial registration 242 and verification 244 are performed, following which the traveler 110 specifies at least one destination 246 and enters a narrative 248 to accompany their videos and “pitch” or “sell” their reasons for travel. The traveler 110 uploads, via the upload function 250 of the traveler user interface 240, at least one of the entertaining media items 120, and the server 150 stores, in the database 152 of user performances, the uploaded entertaining media items 120.

Following a subsequent viewer query 222 that “hits” on a media item of the traveler 110, the server 150 renders, via the viewer user interface, a queried one of the uploaded media items 120′. A successfully entertained viewer 130 may then elect a monetary contribution 224 such that the viewer user interface 220 receives the indication of a monetary transfer following completing of the rendered entertaining media item 120. The viewer 130, of course, traverses the registration page prior to querying for customary administrative tasks, discussed further below.

The server 150 maintains operations by receiving a percentage (typically 2.5%) of donated amounts, and from advertiser revenues from buying or bidding on banner space attributable to a particular destination 104. An advertiser 140 may identify 282, based on a travel destination 204 specified on the advertiser interface 280, travelers 110 having a common travel destination, and the server 150 renders, based on the common travel destination, commercial media 142 pertaining to the common travel destination 284 via the traveler interface 240.

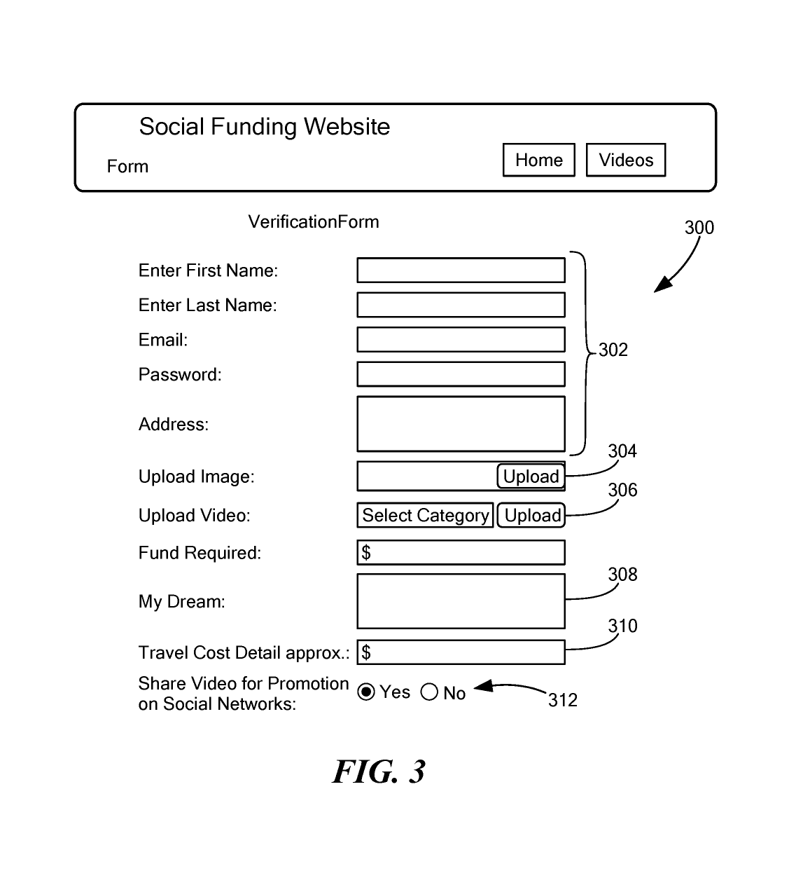

FIG. 3 is a diagram of a traveler user interface 300 rendered by the server 150 of FIG. 2. Referring to FIGS. 1-3, the entertaining media item 120 associates a travel destination 104 with an impetus for traveling there such that the reasons or story appeals to the viewer 130. Traveler personal information 302 is entered, followed by images 304 or video 306 that define the entertaining media content 120. A destination and optional narrative describing reasons for travel are entered in a “dream” box 308, and a monetary FIG. 310 or goal needed for travel to the destination 104 is also entered.

A social network interface election may also be entered. As with any user community or collection, interactions between the community provides meaningful exchanges and reinforces users reasons for return. Accordingly, the uploaded entertaining media items 120 may also be shared on other social platforms. The social platform would provide an ability for individual(s) to post the entertaining videos on the platform and share to make it “viral,” a phenomenon that can reflect positively on the poster and generate additional entertainment value. The platform interface will allow people to upload any kind of entertainment videos to entertain the public and encourage them to fund their dream. The videos can of any type as hilarious/emotional/influential/mimicry etc. The campaigning will be launched publicly and encourage public to raise funds.

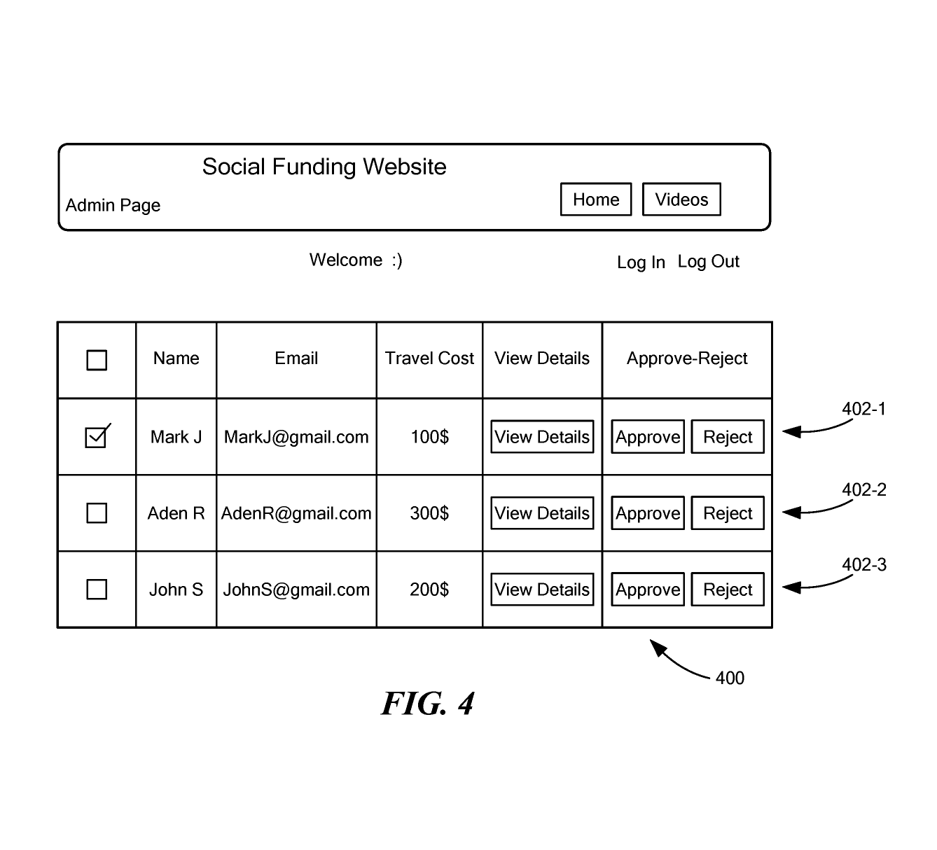

FIG. 4 is an administrator interface 400 for evaluating new travelers invoked by the traveler interface of FIG. 3. The administrator interface 400 allows retrieval of personal information 402-1 . . . 402-3 of other users (it should be noted that viewers 130 and travelers 110 are both users).

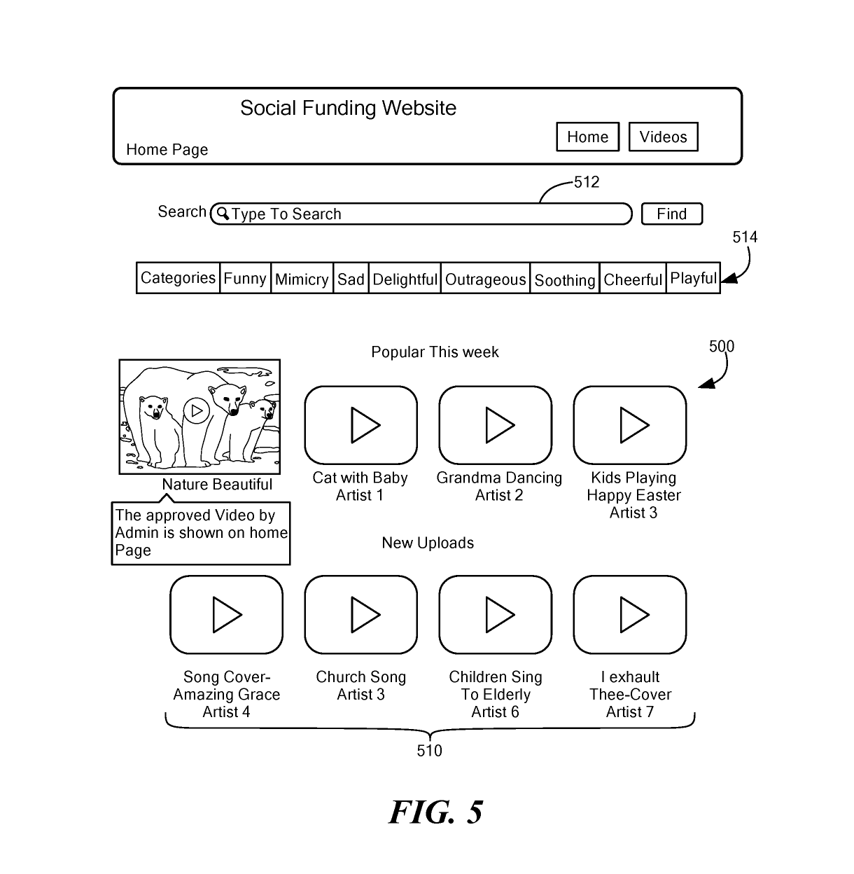

FIG. 5 is a home page 500 invokable by viewers for previewing entertaining media items 120 uploaded by the traveler interface of FIG. 3. The home page 500 receives, from at least one viewer of the plurality of viewers, a query 512 for the entertaining media item, such that the dissemination of the available media items 510 is based on a query corresponding to the destination. Viewers 130 may also elect a genre 514 along with search keywords for viewing thumbnails of the available media items 510 based on the query.

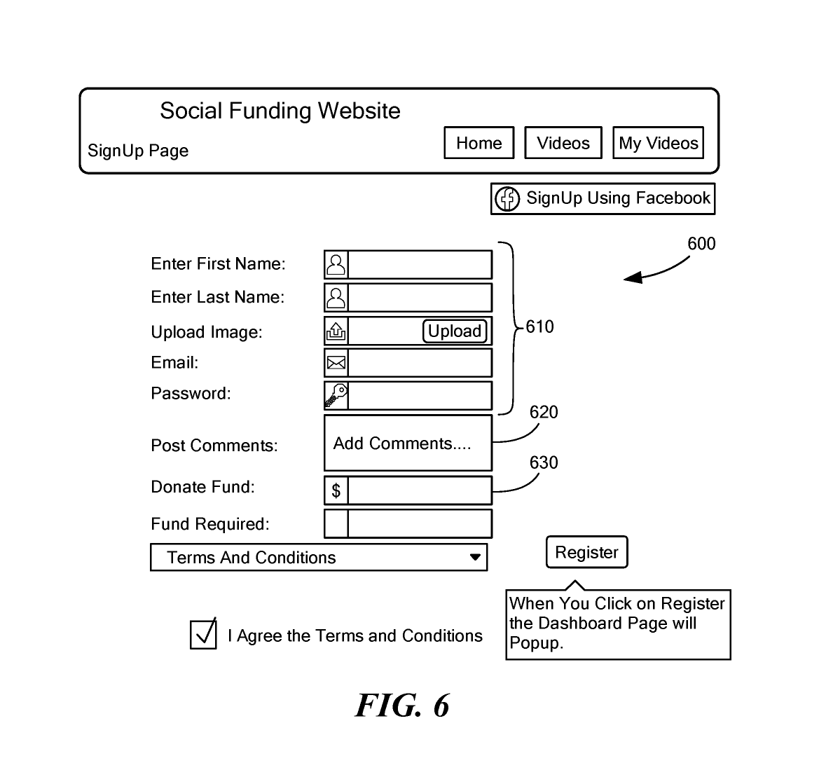

FIG. 6 is a viewer interface invokable to enter funds for dissemination to travelers. One objective of the server is to develop a social fundraising platform for travelers to chase their traveling dream by bringing their respective talent to the market and entertain the community of viewers 130. The platform will be a portal for individuals to entertain themselves and fund the entertainers to fulfill their dreams. Referring to FIGS. 6 and 2, funding results from favorably entertained viewers 130 who invoke the donation function 224. A funding screen 600 allows entry of the personal information of the viewer 610, any comments 620 on the rendered media item 120′, and a monetary amount 630, along with payment details.

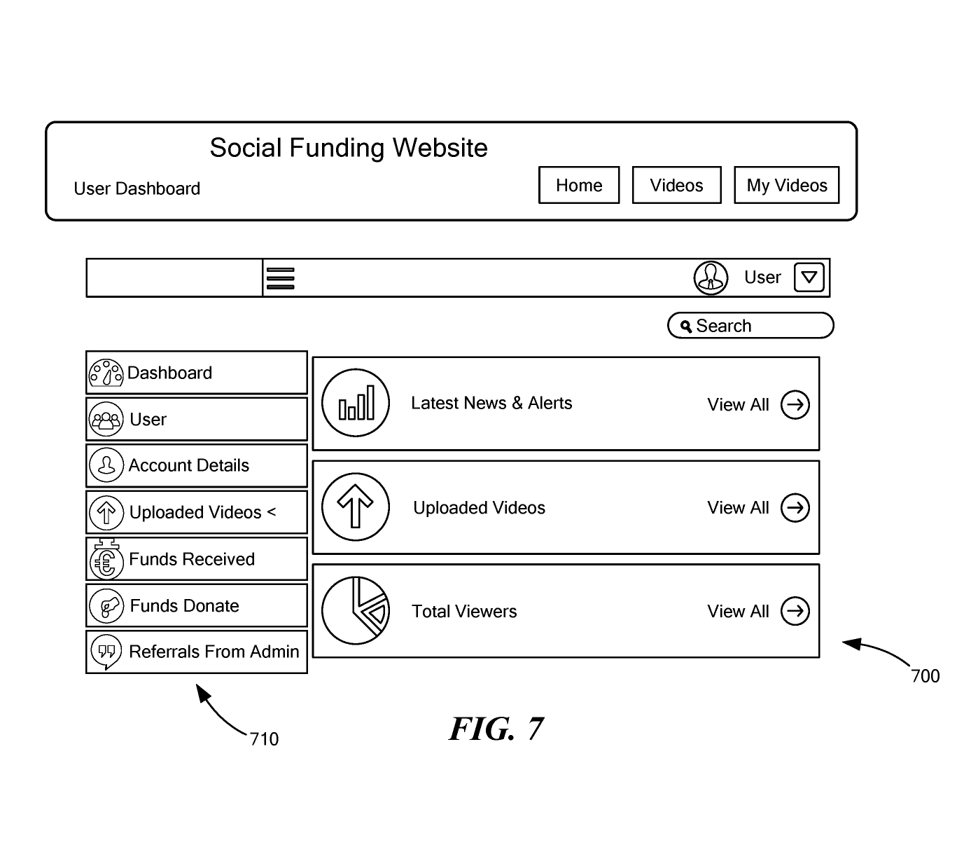

FIG. 7 is a dashboard view accessible from the traveler interface or the viewer interface. The dashboard view 700 allows access to general user parameters 710, including their personal information, uploaded videos, and funds donated and received. Although it may be atypical for a user to both donate and receive funds, such operation may be performed.

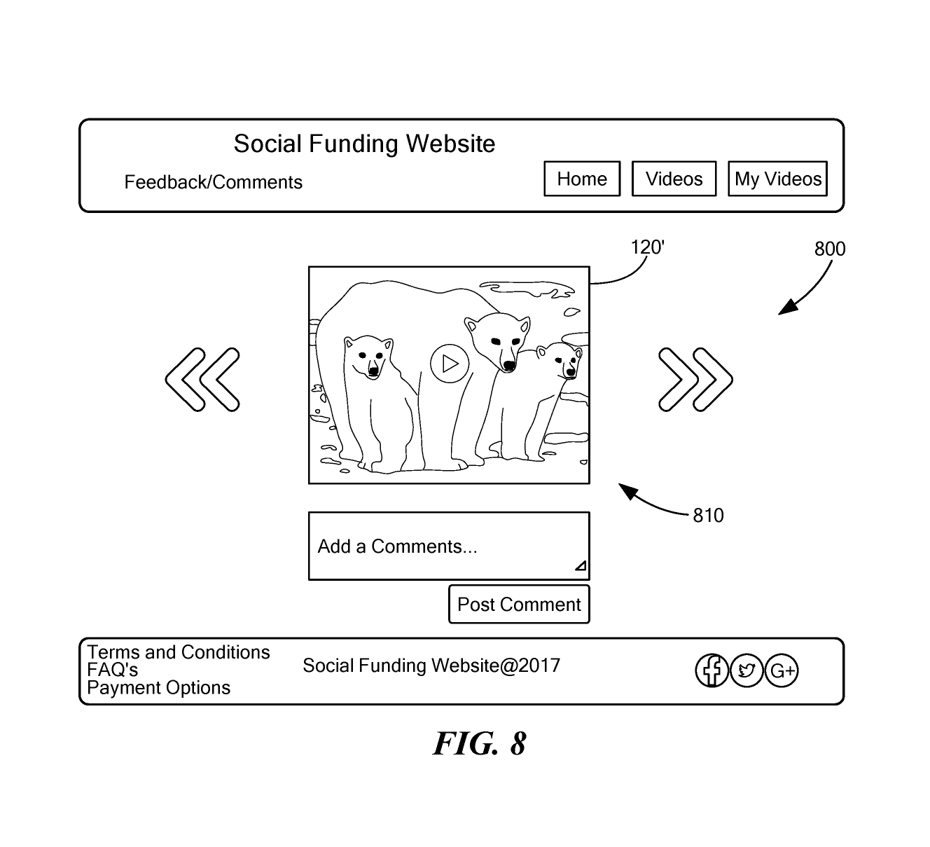

FIG. 8 is a rendering screen 800 for viewing entertaining media items and selecting a donation amount. Referring to FIGS. 5, 6 and 8, viewers 130 elect rendered media items 120′ for viewing on a screen as in FIG. 5. The content 810 of the entertaining media item 120′ is selected based on a persuasion of a viewer 130 to donate the monetary contribution towards travel by the user to the destination 104. An amount of the monetary contribution 530 is based on a perceived entertainment level of the entertaining media item.

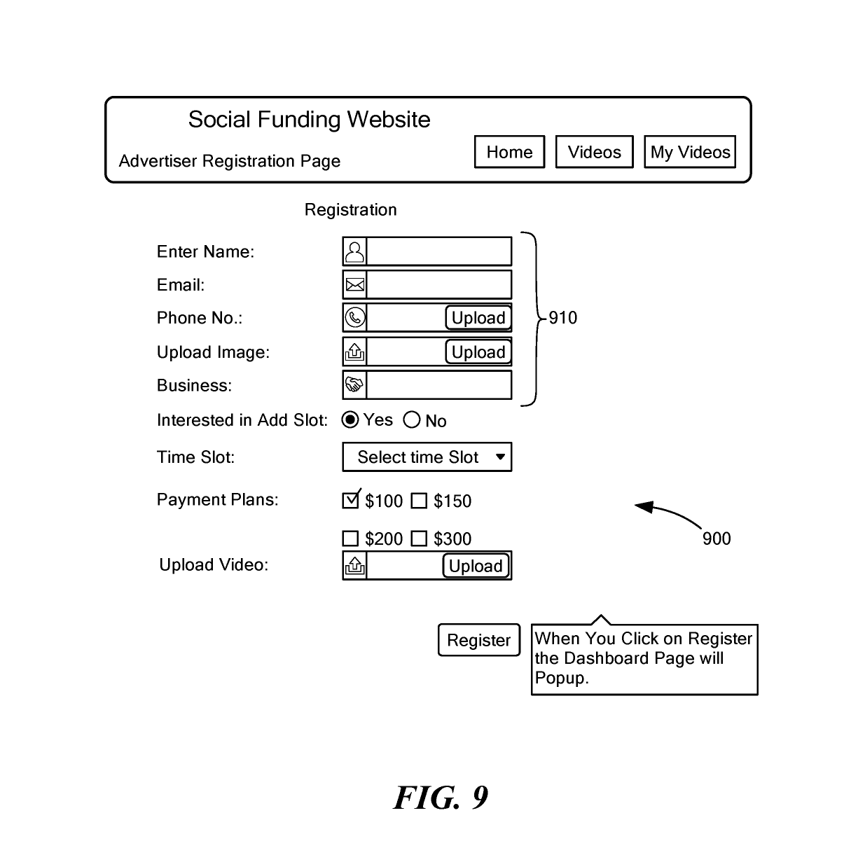

FIG. 9 is an advertiser interface for indicating commercial interests in a travel destination. Referring to FIGS. 2 and 9, the advertiser interface 280 includes a third party video editor to allow the admin to post advertisement campaigns over the posted videos, such as by banners, pop-ups or margin content. An advertiser entry 900 allows entry of personal information 910 of the advertiser, along with other monetary and placement information. In operation, this would include receiving, from an advertiser 140, promotional content 142, and rendering, to the viewers 130 and/or travelers, the promotional content during receipt of the entertaining media item. Such promotional content may be various forms, including a video segment rendered prior to dissemination of the entertaining media item, or a banner rendered in a margin area surrounding the disseminated entertaining media.

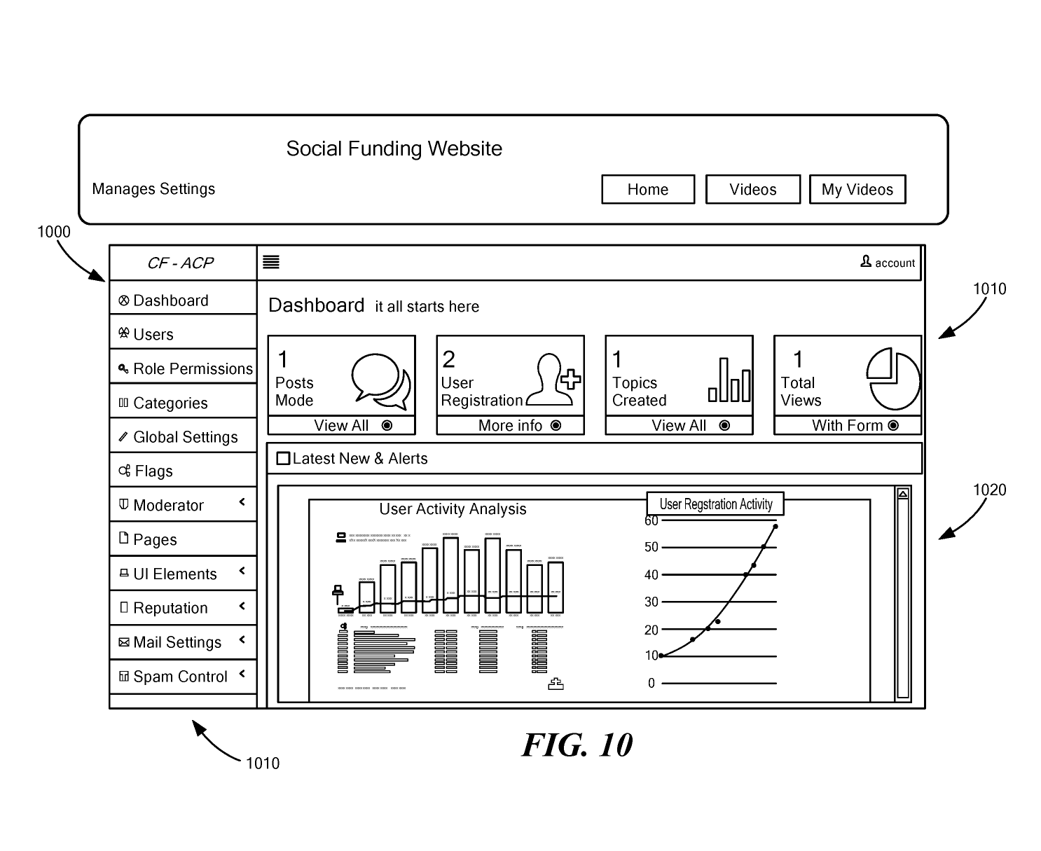

FIG. 10 is an administrative dashboard for identifying entertaining media items uploaded by travelers and rendered to viewers. Referring to FIGS. 2 and 10, the administrative interface 260 allows administrative and privileged operations and rendering. An administrative dashboard allows selection of administrative areas 1010. Various selections 1010 permit topical selections, and analysis windows provide trending and graphical renderings of the information stored in the database 152 for particular users.

In one model, the administrator entity of the server 150 application would be taking appr. 2.5% per funded transactions on the application 154 apart from the commercials added to every video. The business plan is to serve travel and hotel industry for the targeted countries. They will post their advertisements/offers on the platform and gain traffic which will be the additional source of income to the client. The admin process will be thoroughgoing to manage the entire application.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. In a public networking environment, a method of associating entertainment compensation with travel funding comprising:
receiving, from a user, an entertaining media item for appealing to a plurality of viewers receiving the entertaining media item via the public network;
receiving, in conjunction with the entertaining media item, a destination for which travel funding is sought by the user;
disseminating, based on a request from a browsing user, the entertaining media item; and
associating, based on an approval of a viewer of the plurality of viewers, a monetary contribution from the view towards a travel expense incurred by the user in traveling to the destination.

2. The method of claim 1 further comprising receiving, from at least one viewer of the plurality of viewers, a query for the entertaining media item, the dissemination based on the query corresponding to the destination.

3. The method of claim 1 further comprising:
receiving, from an advertiser, promotional content; and
rendering, to the viewers, the promotional content during receipt of the entertaining media item.

4. The method of claim 3 wherein the promotional content includes at least one of:
a video segment rendered prior to dissemination of the entertaining media item; or
a banner rendered in a margin area surrounding the disseminated entertaining media.

5. The method of claim 1 wherein the content of the entertaining media item is selected based on a persuasion of a viewer to donate the monetary contribution towards travel by the user to the destination.

6. The method of claim 1 wherein an amount of the monetary contribution is based on a perceived entertainment level of the entertaining media item.

7. The method of claim 1 wherein the entertaining media item includes one or a sequence of a video track, audio track or still image.

8. The method of claim 1 wherein the entertaining media item associates a travel destination with an impetus for traveling there.

9. The method of claim 1 further comprising:
rendering a user interface for a traveler seeking funding;
rendering a user interface for a viewer responsive to entertaining media items uploaded via the traveler user interface
rendering a user interface for advertisers to specify commercial media;
uploading, via the traveler user interface, at least one of the entertaining media items; and
storing, in a database of user performances, the uploaded entertaining media items;
rendering, via the viewer user interface, a queried one of the uploaded media items; and
receiving, via the viewer user interface, an indication of a monetary transfer following completing of the rendered entertaining media item.

10. The method of claim 9 further comprising:
identifying, based on a travel destination specified on the advertiser interface, travelers having a common travel destination; and
rendering, based on the common travel destination, commercial media pertaining to the common travel destination via the traveler interface.

11. A website server device for associating entertainment compensation with travel funding comprising:
an interface for receiving, from a user, an entertaining media item for appealing to a plurality of viewers receiving the entertaining media item via the public network;
an interface for receiving, in conjunction with the entertaining media item, a destination for which travel funding is sought by the user;
a rendering interface for disseminating, based on a request from a browsing user, the entertaining media item; and
a payment interface for associating, based on an approval of a viewer of the plurality of viewers, a monetary contribution from the view towards a travel expense incurred by the user in traveling to the destination.

12. The device of claim 11 wherein the rendering interface is configured to receive, from at least one viewer of the plurality of viewers, a query for the entertaining media item, the dissemination based on the query corresponding to the destination.

13. The device of claim 11 further comprising:
an advertiser interface operable to
receive, from an advertiser, promotional content
render, to the viewers, the promotional content during receipt of the entertaining media item, the promotional content including at least one of:
a video segment rendered prior to dissemination of the entertaining media item, or
a banner rendered in a margin area surrounding the disseminated entertaining media.

14. The device of claim 1 wherein the content of the entertaining media item is selectable based on a persuasion of a viewer to donate the monetary contribution towards travel by the user to the destination.

15. The device of claim 1 wherein an amount of the monetary contribution is based on a perceived entertainment level of the entertaining media item.

16. The device of claim 1 wherein the entertaining media item includes one or a sequence of a video track, audio track or still image.

17. The device of claim 1 wherein the entertaining media item associates a travel destination with an impetus for traveling there.

18. The device of claim 1 further comprising an application configured to:
render a user interface for a traveler seeking funding;
render a user interface for a viewer responsive to entertaining media items uploaded via the traveler user interface
render a user interface for advertisers to specify commercial media;
upload, via the traveler user interface, at least one of the entertaining media items;
store, in a database of user performances, the uploaded entertaining media items;
render, via the viewer user interface, a queried one of the uploaded media items; and
receive, via the viewer user interface, an indication of a monetary transfer following completing of the rendered entertaining media item.

19. The device of claim 18 wherein the application is further configured to:
identify, based on a travel destination specified on the advertiser interface, travelers having a common travel destination; and
render, based on the common travel destination, commercial media pertaining to the common travel destination via the traveler interface.

20. A computer readable medium having computer program code encoded thereon, that, when executed by a processor, performs a method of associating entertainment compensation with travel funding, the method comprising:
receiving, from a user, an entertaining media item for appealing to a plurality of viewers receiving the entertaining media item via the public network;
receiving, in conjunction with the entertaining media item, a destination for which travel funding is sought by the user;
disseminating, based on a request from a browsing user, the entertaining media item; and
associating, based on an approval of a viewer of the plurality of viewers, a monetary contribution from the view towards a travel expense incurred by the user in traveling to the destination.
